(19) United States
(12) Patent Application Publication
(10) Pub. No.: US 2019/0277329 A1
(43) Pub. Date: Sep. 12, 2019

(54) LOW PROFILE NYLON INSERT LOCK NUT

(71) Applicant: RAMCO SPECIALTIES, INC., Hudson, OH (US)

(72) Inventors: Mark S. BOYER, Hudson, OH (US); Richard A. MALSON, Hudson, OH (US); Daniel B. DONOVAN, Hudson, OH (US)

(21) Appl. No.: 16/343,655

(22) PCT Filed: Oct. 19, 2017
(86) PCT No.: PCT/US2017/057398

§ 371 Date: Apr. 19, 2019

Related U.S. Application Data
(60) Provisional application No. 62/410,671, filed on Oct. 20, 2016.

(51) Int. Cl. F16B 39/34; F16B 33/00; C25D 7/00

(52) U.S. Cl. CPC F16B 39/34; C25D 7/003; F16B 33/008

(57) ABSTRACT

The present invention relates to prevailing torque lock nuts and, more particularly, to a low profile lock nut that maintains the same strength as its higher profile counterparts. The present lock nut is a non-metallic lock having an inner recess so as to receive a plastic insert, such as a nylon insert. In some embodiments, the plastic insert is a temperature resistant plastic insert capable of withstanding high temperatures. Further, in some embodiments, the present lock nut is manufactured to have increased hardness levels and subject to enhanced plating process that ensure superior corrosion resistance.

### CROSS-REFERENCE TO RELATED APPLICATIONS

This patent application claims priority to and the benefit of U.S. Provisional Patent Application Ser. No. 62/410,671 filed on Oct. 20, 2016, which is incorporated by reference herein in its entirety.

### BACKGROUND OF THE INVENTION

A nut is a type of fastener with a threaded hole. Nuts are commonly used in conjunction with a mating bolt to fasten two or more parts together. The two partners are kept together by a combination of their threads' friction, stretching of the bolt, and compression of the parts to be held together. There are three (3) general categories of fastener nuts—(i) free spinning, (ii) chemical locking, and (iii) friction locking. The free-spinning varieties are nuts with a circumferential row of teeth under the washer head. These are ramped, allowing the bolt to rotate in the clamping direction, but lock into the bearing surface when rotated in the loosening direction. The “Whizlock” is in this category. The chemical locking category utilizes adhesives, such as Loctite, which fill the gaps between the male and female threads, and bond them together. Such adhesives are available in micro-encapsulated form and can be pre-applied to the thread. Friction locking nuts resist loosening under vibrations and torque via deformation of the nut that, in turn, provides a locking action.

Nuts in the friction locking category are sometimes referred to as lock nuts, locking nuts, prevailing torque nuts, stiff nuts, or elastic stop nuts, and these lock nuts may be subdivided into two (2) groups: (i) metallic and (ii) non-metallic. Both of these varieties “lock” via elastic deformation of a portion of the nut against the male thread, and the operational principle of both is that the interference fit prevents relative lateral movement (which is a contributor to loosening under vibration) in the threads (i.e., prevents movement perpendicular to the thread axis).

The metallic friction locking fastener (i.e., a metallic lock nut) usually has distorted threads that provide a prevailing torque. This type of nut's thread is typically manufactured either slightly out-of-round or undersize, necessitating elastic deformation of the nut as it's threaded onto the male thread. An example of this category is the “Philidas” nut. Metallic lock nuts, however, may cause galling or coating damage.

Non-metallic friction locking devices (i.e., non-metallic lock nuts) have polymer or plastic inserts (e.g., Nylon) that provide a thread locking function. The deformation is caused by the male thread impressing into the plastic insert as the plastic passes over the male thread. In addition, non-metallic lock nuts such as nylon lock nuts may provide a dampening function. One such example of a non-metallic nylon lock nut is the “Nyloc” nut. These non-metallic lock nuts, however, are significantly “taller” than their metallic lock nut counterparts when measured from face end to opposing face end. Moreover, the inserts of the non-metallic lock nuts may have temperature constraints that limit their application.

Prevailing torque is the amount of torque needed to run a nut down a thread on nuts that are designed to resist self-loosening under vibratory forces. The concept of prevailing torque differentiates a lock nut from a free-spinning nut based on a value of how much torque is required during installation before clamp loading. For example, on a nylon insert nut, prevailing torque is the torque needed to overcome the resistance of the nylon dragging across the mating thread. This torque value is usually not very high relative to final drive torque that clamps or tightens the nut to its counterpart. Tolerance ranges for torque are specified in some standards such as ISO, DIN, IFI, ASME, SAE, AN-, MS-, NAS-NASM-.

### SUMMARY OF THE INVENTION

Presently disclosed is a lock nut. In one embodiment, a lock nut comprises a body having a plurality of faces that extend upward from a bottom end of the body and terminate at a neck that extends upward therefrom and terminates at a top end of the body. The lock nut also includes a bore that extends through the body from the top end to the bottom end. In this embodiment, the bore further comprises a threaded portion that extends upward from the bottom end and includes a plurality of threads and an unthreaded portion that extends upward from the threaded portion and defines a recess that laterally extends into the body. Moreover in this embodiment, the lock nut also includes an insert that is arranged in the recess and includes an insert bore that aligns with the threaded portion of the bore.

In another embodiment, a method of manufacturing a low profile lock nut is provided. In such embodiment, the method includes providing a lock nut having an upwardly extending body and a neck portion at an upper end of the body, where the neck portion is open at an upper end thereof, and where the lock nut further comprises a bore that extends through the body such that the bore includes an unthreaded portion that corresponds with at least the neck portion and defines a recess that laterally extends into the body. The method further includes applying a coating to the lock nut, inserting an insert through the upper end of the neck portion and into the recess, coining the upper end of the neck portion to form a hooked lip, and applying a top coat to the lock nut.

These and additional features provided herein will be more fully understood in view of the following detailed description in conjunction with the drawings.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function without departing from the scope of this disclosure.

FIG. 1 is a partial cutaway side view of an example lock nut that may incorporate the principles of the present disclosure.

FIG. 2 is illustration of the lock nut of FIG. 1 without the insert and depicts the orientation of the recess therein.

FIG. 3 is a partial cutaway side view of the lock nut of FIG. 1 that depicts the orientation of the insert within the recess.

FIG. 4 is a top view of the lock nut of FIG. 1.

FIG. 5 is a bottom view of the lock nut of FIG. 1.

### DETAILED DESCRIPTION

The present disclosure is related to lock nuts and, more particularly, to lock nuts with inserts that assist in locking the lock nuts.

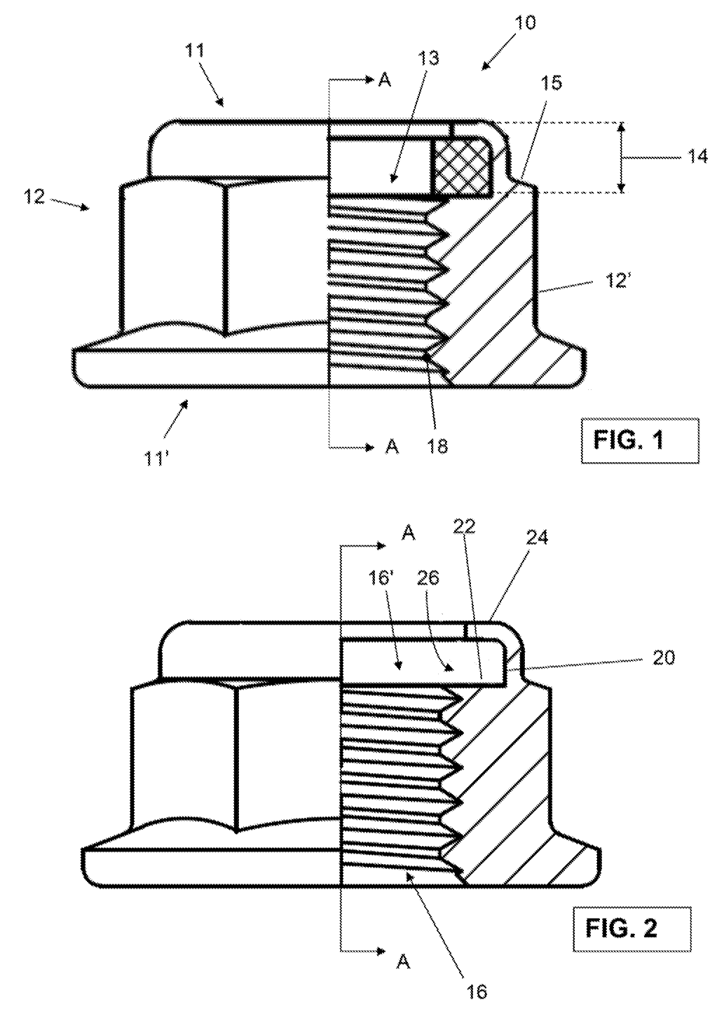

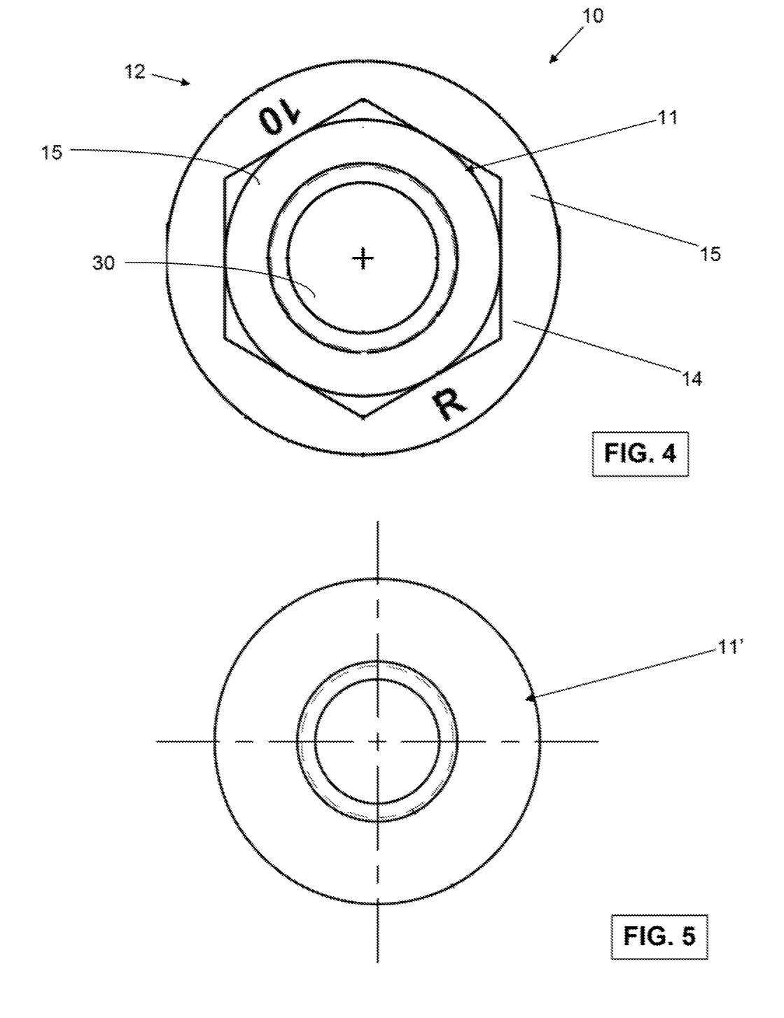

FIGS. 1-5 are various views of a lock nut 10 that may incorporate the principles of the present disclosure. The illustrated lock nut 10 has a hexagonal geometry and is just one exemplary lock nut that may suitably incorporate the principles of the present disclosure. Indeed, many alternative designs, geometries, and configurations of the lock nut 10 may be employed without departing from the scope of this disclosure.

In the illustrated embodiment, the lock nut 10 is a mixed material lock nut having an insert that may be made from a polymer or plastic material (i.e., a metallic nut with a nylon insert). In addition, the lock nut 10 has a body height (i.e., a wrench height) that is same or nearly identical to the body height (and thus wrenching height) of a comparable class of metallic lock nut (e.g., hex nut height for property class (PC) 10). In one embodiment, the lock nut 10 has the characteristics of a PC 10 steel hexagonal nut variety as specified in ISO 898-2. In addition, the lock nut 10 may conform to ISO 8992 Product. Grade A. It will be appreciated, however, that other types of nuts may be utilized depending on the particular application (e.g., acorn nuts, wing nuts, square nuts, nut/washer assemblies, etc.). Moreover, it will be appreciated that lock nut 10 may be manufactured from any number of materials depending on the particular application, including but not limited to metals (e.g., steel, titanium, iron, etc.) and/or non-metals (e.g., carbon, carbon fiber, ceramic, etc.).

In some embodiments, the lock nut 10 is subject to a quenching and tempering heat treatment process that makes its components/parts particularly hard and tough, which in turn increases the applications in which the lock nut 10 may be utilized. Thus, the lock nut 10 may be utilized in severe conditions. For example, in one embodiment the lock nut 10 has a hardness in the range of about. HRc 33-39; however, other hardnesses may be implemented depending on the particular application.

The lock nut 10, according to the present disclosure, has a prevailing torque that may vary depending on the materials utilized and the particular end use application. For example, the lock nut 10 may have a geometry and prevailing torque of ISO 7043. In addition, the lock nut 10 may be provided to meet the performance and testing requirements of ISO 2320 (which specifies the prevailing torque requirements). For example, ISO 2320 specifies that the lock nut 10 should be capable of being reused five (5) times but still retain a prevailing torque. Accordingly, the lock nut 10 according to one or more embodiments may be reusable, at least to some extent.

With reference to FIG. 1 and FIGS. 4-5, the lock nut 10 comprises opposing ends. In the illustrated embodiment, the lock nut 10 includes a circular top end 11 and flanged and circular bottom end 11′; however, other geometries (and/or combinations of geometries) of the ends may be utilized, for example, depending upon the style of lock nut selected. The lock nut 10 further comprises a nut body 12 having a portion 12′ that is adapted to be received by a tool (e.g., a socket or wrench) and a concentric neck extension 14 (or neck 14) that are interposed by a shoulder 15. In the illustrated embodiment, the portion 12′ of the nut body 12 includes six (6) vertically oriented faces arranged in a hexagonal nut configuration that may be received by an appropriately dimensioned tool driver having a corresponding geometry. Also in the illustrated embodiment, the neck extension 14 begins at circular end face 11, extends downward along an axis A-A towards the face end 11′, and terminates at a location therebetween, for example, at the shoulder 15 that interposes the neck extension 14 and the portion 12′ of the nut body 12 that is adapted to be received by a tool. It will be appreciated, however, that other orientations and dimensions may be utilized when positioning neck extension 14. For example, in some embodiments, the neck extension 14 may be taller or shorter (along axis A-A) relative to the portion 12′ and/or the portion 12′ of the nut body 12 may be taller or shorter relative to the neck extension 14.

The lock nut 10 also includes a central bore 13 that extends axially through the length of lock nut 10 along the axis A-A. In the illustrated embodiment, the central bore 13 includes internal threads 18 that are formed within at least a portion of the central bore 13, as hereinafter described. The internal threads 18 are sometimes referred to as the “nut thread” or “female thread,” and in at least some embodiments the internal threads 18 are cut or formed in the central bore 13 as will be appreciated by those skilled in the art.

The threads 18 may be of any standard size. For example, the threads 18 may be any of the M6 thread size through the M18 thread size standards. It will be appreciated, however, that other “M” designation thread sizes may be utilized other than those in the M6 to M18 range. In one particular application, the threads 18 conform to General Motors (GM) Specification GMW 16551. In other embodiments, the threads 18 conform to any of the British thread standards, such as the British Standard Whitworth. In some of these other embodiments, threads 18 are about ¼″ to ¾″ English thread sizes; however, others may be utilized. The manner in which threads 18 are arranged within the central bore 13 of the nut body 12 is detailed below.

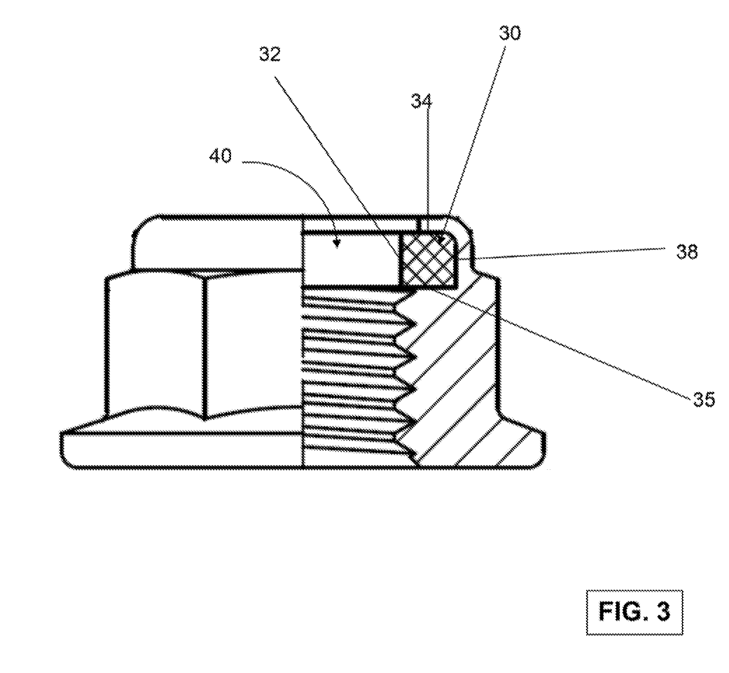

The central bore 13 may include different sections or bore portions. As illustrated in FIG. 2, for example, the central bore 13 may include (i) a threaded bore portion 16 that extends through a length of the central bore 13 along axis A-A and includes the threads 18 and (ii) an unthreaded bore portion 16′ that extends through a remaining length of the central bore 13 along axis A-A. Here, the threaded bore portion 16 is oriented below the unthreaded bore portion 16′. In the illustrated embodiment, the unthreaded bore portion 16′ corresponds with the neck extension 14 (which is proximate to the face end 11), the shoulder 15, and at least an upper segment of the portion 12′ of the nut body 12 that receives a tool. In other unillustrated embodiments, however, the unthreaded bore portion 16′ corresponds with the neck extension 14, but terminates at a top or bottom of the shoulder 15. It will also be appreciated that in other embodiments, the unthreaded bore portion 16′ may be arranged differently within the central bore 13. For example, it may be arranged at a location along the axis A-A between the face ends 11,11′ such that the threaded bore portion 16 is divided into two (2) bore portions (i.e., having equal or unequal lengths). In even other embodiments, two (2) or more unthreaded bore portions 16′ may be arranged within the central bore 13 such that the threaded bore portion 16 is divided into two (2) or more bore portions (having equal or unequal lengths).

As illustrated in FIG. 2, the unthreaded bore portion 16′ defines a recess 26 that has a larger bore diameter than that of the threaded bore portion 16. In the illustrated embodiment, the recess 26 is an annularly shaped cavity or socket that is arranged to receive or accommodate a locking device or an insert 30, and such insert is further described below. Accordingly, the recess 26 is bounded along its outer circumference by an offset bore wall 20, and is bounded on the bottom and top by a shoulder wall 22 and an inner wall of the hooked lip 24, respectively. Here, the offset bore wall 20 is offset towards the exterior of lock nut body 12 with respect to axis A-A, and the amount of such offset defines the outer diameter of the recess 26, as well as the lateral lengths (i.e., perpendicular to the axis A-A) of the shoulder wall and hooked lip 24. As illustrated, the shoulder wall 22 may mark or define a first boundary of the unthreaded bore portion 16′, whereas the inner wall of the hooked lip 24 may define the other boundary of the unthreaded bore portion 16′.

Also in the illustrated embodiment, the recess 26 (that does not include the threads 18) overlaps (i.e., corresponds with) both the neck extension 14 and the body portion 12′ that is arranged to receive a tool. Accordingly, the threads 18 need not be not formed within the entirety of nut body 12 or even within the entirety of the portion 12′ that is adapted to be received by a tool. However, in other embodiments, the recess 26 does not overlap into the body portion 12′ that is arranged to receive a tool, but instead corresponds only with the neck extension 14 and/or the shoulder 15.

In one embodiment, the recess 26 is formed by an extrusion process. For example, the nut body 12 may be extruded to form the recess 26 so that it axially extends into the portion 12′ of the nut body 12 that is received by the a tool (e.g., a wrench). While a nut lock 10 manufactured via the foregoing process may have less threads 18 within its central bore 13 than other conventional nut locks, it may nevertheless operate in high load/stress applications by having enhanced property characteristics, for example, increased hardness. It will be appreciated, however, that the foregoing is a nonlimiting example and that other methods may be utilized to form recess 26, for example, by machining.

The recess 26 may have varying dimensions and geometries depending on the ultimate end use application. For example, the recess 26 may be taller and/or may extend further down within the central bore 13 than as illustrated. Thus, the insert 30 may be positioned at various recess locations along the central bore 13 depending on the dimensions, geometry, and/or location (along axis A-A) of recess 26.

In an illustrated embodiment, the insert 30 is a nylon washer (or annular disc) manufactured independent of nut body 12 utilizing a heat stabilized polyamide 46 that is suitable for high temperature applications in the operating range of about −50° C. to 160° C. Various manufacturing methods may be utilized to manufacture the insert 30, for example, molding or stamping. It will be appreciated that other insert materials may be utilized to aid in locking a fastener (e.g., a screw or bolt) received within the lock nut 10, for example, Nylon 6.6 or any number of other polymers. It will be appreciated, however, that the selection of any such material may depend on the various constraints and parameters of the end use application. In one embodiment, the insert 30 is inserted into the recess 26 and then the end face 11 is coined over to form the hooked lip 24 as illustrated; however, other methods of positioning and/or fixing the insert 30 into or within the recess 26 may be utilized, for example, by press-fitting insert 30 into the recess 26.

As illustrated in FIG. 3, the insert 30 comprises an inner bore 32 and, in at least some embodiments, the inner bore 32 diameter is smaller than the major diameter of threads 18 but larger than the minor diameter of the threads 18. Thus, when the lock nut 10 is screwed on a bolt (not depicted), the bolt threads (not depicted) impress threads (not illustrated) in the insert 30.

The insert 30 may be ring or annular in shape and thus include a correspondingly shaped top and bottom surface 34,35, as well as an outer circumferential surface 38. In the illustrated embodiment, the top and bottom surfaces 34,35 include central openings that together define an insert bore or central opening 40 is in alignment with the central bore 13, and in some embodiments, the insert bore 40 is coaxial with the central bore 13 and/or the threaded bore portion 16. In addition, the top and bottom surfaces 34,35 may be oriented substantially perpendicular to axis A-A to engage the inner wall of the hooked lip 24 and the shoulder wall 22, respectively, when the insert 30 is installed within the recess 26, whereas the outer circumferential surface 38 engages the offset wall 20 when the insert 30 is installed within the recess 26. Thus, the insert 30 is held in place within the recess 26 by the offset wall 20, the hooked lip 24, and the shoulder wall 22; and in some embodiments, the insert 30 is locked or secured within the recess 26 so as to not move or rotate relative to the nut body 12 or otherwise loosen. In even other embodiments, adhesives are utilized to further secure the insert 30 within the recess 26 such that it does not move or rotate relative to the nut body 12. In other embodiments, one or more protrusions (or other mechanical fastener structures) are formed on any or all of the top and bottom surfaces 34,35 or the outer circumferential surface 38 that engage the insert 30 to prevent or restrict relative movement.

In some embodiments, the insert 30 has an annular protrusion or crown (not illustrated) at the circular face end 11 when the hooked lip 24 is formed or coined. In such embodiments, the crown may extend axially along axis A-A above or beyond the offset wall 20 and hooked lip 24 so as to protrude from the face end 11 of lock nut 10. During use of such a lock nut with a crown, the crown may fold outwardly upon itself and provide additional locking capabilities. In addition, the crown may provide a sealing function so as to inhibit any fluid escaping beyond face end 11.

In one embodiment, lock nut 10 (without the insert 30 therein) is subject to a coating and finishing process. In that embodiment, the surfaces of nut body 12 are coated, for example, with electroplated zinc-nickle (ZiNi) which will provide protection against corrosion. In one specific example, the nut body 12 is electroplated with ZiNi, Type B, Grade G (GMW 4700; ZinKlad 1000; SST 240/1000). Other coatings may be utilized, however, as appreciated by those skilled in the art. Thereafter, the nut body 12 is subject to a baking process after coating so as to relieve hydrogen embrittlement (e.g., as specified in GMW 4700 or GMW 4707). The foregoing coating and finishing process may be performed on any surface of nut body 12 and, in an illustrated embodiment, all surfaces of the lock nut body 12 are electroplated as previously described, including surfaces between insert 30 and the nut body 12 such as inner surfaces of offset wall 20, shoulder wall 22, and hooked lip 24. Therefore, nut body 12 may be subject to the coating and finishing process before insert 30 is installed and secured therein via the coining process; however, in other embodiments, the nut body 12 with insert therein are subject to the foregoing coating and finishing processes. It will also be appreciated that when the coining process is utilized, the hooked lip 24 may be provided in an unhooked or unformed orientation (i.e., it extends vertically in an unfolded orientation to define an open circular or cylindrical structure, rather than being hooked or folded inwardly), and then coined over into the formed or hooked orientation, for example, as illustrated with regard to the hooked lip 24 depicted in the figures.

In embodiments where the foregoing coating and finishing process are performed before the insert 30 is installed in recess 26 and secured therein (e.g., by coining end face 11), a separate top coat may thereafter be applied to nut body 12 so as to ensure the entirety of nut body 12 is fully coated, as the coining process may remove previously applied coating. The top coat may be any corrosion-resistant top coat known in the art, for example, those produced by The Magni Group or Darken MKS. In another embodiment, the top coat is a UV fluid top coat such as those manufactured by MacDermid Industrial Solutions or Teflon®. Furthermore, all surfaces of nut body 12 may be finished to be free of burrs, laps, cracks, seams, voids, flashing, or other discontinuities, which may inhibit assembly, safe handling, appearance, and function. For example, all surfaces of nut body 12 may conform to ISO 6157-2. While optional, the foregoing coating and finishing processes provide enhanced protection against corrosion and provide broad applicability of lock nut 10.

The foregoing manufacturing and assembly protocols may provide a metal lock nut 10 with a plastic-type insert 30 therein, wherein the lock nut 10 has a reduced height that matches that of a conventional all metallic lock nut (i.e., an all metal prevailing torque nut or metallic friction locking fastener). Thus, the lock nut 10, according to the present disclosure, may have the same (and even improved) locking and operational characteristics of a standard nylon lock nut (e.g., a PC-10 nylon lock nut), but with the smaller dimensions (i.e., reduced height/profile and weight) that are similar to those of conventional metallic lock nuts. Accordingly, the lock nut 10 may be provided with the standard wrenching height of an all metal prevailing torque nut despite the fact that it is instead a nonmetallic lock nut. Unlike metallic lock nuts, however, the lock nut 10 may be reusable in the same manner as standard nylon lock nuts. Even further, the lock nut 10 may be screwed onto a fastener such as a bolt without removing the coating (if any) therefrom as would the all metal lock nut variety due to the manner in which it locks (i.e, via deformation). Instead, the lock nut 10 of the present disclosure will enhance the overall joint corrosion characteristics and performance during actual use. For example, a lock nut 10 manufactured as detailed above will be able to resist corrosion to the same extent as metallic lock nuts despite the process used to install a nonmetallic insert therein. Moreover, lock nut 10 will have increased hardness, thereby permitting lock nut 10 to have fewer threads 18 than comparable standard nonmetallic lock nuts, but nevertheless maintain the requisite proof load capabilities so as to perform similar in accord with a standard nylon lock nut.

While principles and modes of operation have been explained and illustrated with regard to particular embodiments, it must be understood, however, that this may be practiced otherwise than as specifically explained and illustrated without departing from its spirit or scope. Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

The use of directional terms such as above, below, upper, lower, upward, downward, left, right, lateral and the like are used in relation to the illustrative embodiments as they are depicted in the figures, the upward or upper direction being toward the top of the corresponding figure and the downward or lower direction being toward the bottom of the corresponding figure.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

As used herein, the terms “about” and “approximately” mean plus or minus 15% of the numerical value of the number with which it is being used. Therefore, “about 40” (or “approximately 40”) means “in the range of 34 to 46.” It is also noted that the terms “generally” and “substantially” may be used herein to represent the inherent degree of uncertainty that may be attributed to any quantitative comparison, value, measurement, or other representation. These terms are also used herein to represent the degree by which a quantitative representation may vary from a stated reference without resulting in a change in the basic function of the subject matter at issue.

1. A low profile lock nut comprising:
a body having a plurality of faces that extend upward from a bottom end of the body and terminate at a neck that extends upward therefrom and terminates at a top end of the body;
a bore that extends through the body from the top end to the bottom end, the bore further comprising:
a threaded portion that extends upward from the bottom end and includes a plurality of threads and
an unthreaded portion that extends upward from the threaded portion and defines a recess that laterally extends into the body; and
an insert that is arranged in the recess and includes an insert bore that aligns with the threaded portion of the bore.

2. The low profile lock nut of claim 1, wherein the insert is a nylon insert.

3. The low profile lock nut of claim 2, wherein the nylon insert comprises a heat stabilized polyamide.

4. The low profile lock nut of claim 1, wherein the insert bore includes a plurality of insert threads.

5. The low profile lock nut of claim 1, wherein the insert is ring shaped.

6. The low profile lock nut of claim 1, wherein the lock nut has a hardness of about HRc 33-39.

7. The low profile lock nut of claim 1, wherein the lock nut conforms to ISO 898-2.

8. The low profile lock nut of claim 1, wherein the recess is an annular recess.

9. The low profile lock nut of claim 1, wherein the threads are ISO metric screw threads in the range of M6 to M18.

10. The low profile lock nut of claim 1, wherein the threaded portion and the unthreaded portion of the bore are concentric.

11. The low profile lock nut of claim 10, wherein the threaded portion of the bore and the insert bore are concentric.

12. The low profile lock nut of claim 1, wherein the plurality of faces are arranged in a hexagonal nut configuration.

13. The low profile lock nut of claim 1, further comprising a shoulder that interposes the neck and the plurality of faces.

14. The low profile lock nut of claim 13, wherein the unthreaded portion of the bore corresponds with at least a portion of the neck.

15. The low profile lock nut of claim 13, wherein the unthreaded portion of the bore corresponds with the neck and at least part of the shoulder.

16. The low profile lock nut of claim 13, wherein the unthreaded portion of the bore corresponds with the neck, the shoulder, and at least a portion of the plurality of faces.

17. A method of manufacturing a low profile lock nut, the method comprising:
providing a lock nut having an upwardly extending body and a neck portion at an upper end of the body, the neck portion being open at an upper end thereof, the lock nut further comprising a bore that extends through the body, the bore having an unthreaded portion that corresponds with at least the neck portion and defines a recess that laterally extends into the body:
applying a coating to the lock nut;
inserting an insert through the upper end of the neck portion and into the recess;
coining the upper end of the neck portion to form a hooked lip; and
applying a top coat to the lock nut.

18. The method of claim 17, wherein the coating is an electroplating process.

19. The method of claim 17, wherein the lock nut is subject to an additional step following the step of applying a coating to the lock nut, the additional step comprising baking the lock nut.

20. The method of claim 17, wherein the top coat is a corrosion resistant coating.
